(19) United States
(12) Patent Application Publication
(10) Pub. No.: US 2004/0039665 A1
(43) Pub. Date: Feb. 26, 2004

(54) Manufacturing information web service

(76) Inventor: Norman Ken Ouchi, San Jose, CA (US)

Correspondence Address: N. K. OUCHI, 20248 VIEW CREST CT, SAN JOSE, CA, 95120, US

(21) Appl. No.: 10/228,030

(22) Filed: Aug. 26, 2002

(51) Int. Cl. G06F 17/60

(52) U.S. Cl. 705/28

(57) ABSTRACT

The current invention is related to the use of the Internet to track and control items manufactured in a process composed of a sequence of process steps at workcenters. The sequence of process steps and workcenters is described as a route. A shopfloor system is used to control the manufacture of the item by guiding the item through the sequence of workcenters and providing information on the process step to be done at each workcenter. Information on the item as it is manufactured is also collected. The present invention provides a web service where Internet devices are designated as workcenters and provides the functions to track and control the manufacture of items in manufacturing processes described by routes.

### CROSS-REFERENCE TO RELATED APPLICATIONS

None

### STATEMENT REGARDING FEDERALLY SPONSORED RESEARCH OR DEVELOPMENT

None

### FIELD OF THE INVENTION

The current invention is related to the use of the Internet to track and control items manufactured in a process composed of a sequence of process steps at workcenters.

### BRIEF SUMMARY OF THE INVENTION

An item is manufactured by a sequence of process steps where a process step is performed at a workcenter. The sequence of process steps and workcenters is described as a route. A shopfloor system is used to control the manufacture of the item by guiding the item through the sequence of workcenters and providing information on the process step to be done at each workcenter. Information on the item as it is manufactured is also collected. The present invention provides a web service where Internet devices are designated as workcenters and provides the functions to track and control the manufacture of items in manufacturing processes described by routes.

### BACKGROUND OF THE INVENTION

The process to manufacture an item can be a sequence of process steps where a process step is performed at a specified workcenter. Directing the item through the sequence of process step and workcenters can control the manufacture of the item. Information can be sent to the workcenter to perform the manufacturing process step specific to the item. With this level of control, the item can be tracked in the process and information about the item collected as the process manufactures the product. The information may include the results of inspection processes, failure information if the item fails, process parameter values, etc. The manufacturing process may control and track repair process for items that fail inspection processes. In the repair process, it is desirable to collect information about the failure and the steps and material used in the repair. It may not be economically feasible to repair a failed item and the item may be scrapped and parts of the item salvaged for repair of other items. Information on scrapped item can also be collected. Controlling the manufacturing process and collecting information about the items as they are manufactured provides organizations significant opportunities to discover sources of errors and means to improve their manufacturing processes.

Some manufacturing processes are stable and a fixed sequence of processes steps is defined. However, many manufacturing processes are composed of workcenters where each workcenter can perform a different process step. The manufacturing process for a product is defined by the sequence of process steps and the workcenters to perform each process step. A work center can be further tailored to perform a process step for a product by specific instructions to the operator, specific equipment set-up, specific programs for programmable equipment, etc. This level of flexibility and tailoring permits a set of workcenters to manufacture many products.

A structure called the route is used to represent the sequence of process steps and the workcenters at which each process step is executed. A route is illustrated in FIG. 1 where the sequence, Process Step 1 is performed at Workcenter 1, Process Step 2 is performed at Workcenter 2 and Process Step 3 is performed at Workcenter 3 is represented. A manufacturing process to produce a product is represented in the route for that product.

Many manufacturing processes are defined and controlled using paper instructions and paper “travelers” associated with each item of a product as it is manufactured. Programs and computers or terminals at the workcenters have been developed to control and track each item in the manufacturing process and replace the paper-based process definition and control. The programs are called “shopfloor control systems” or “manufacturing execution systems”. The function of a shopfloor system is to record the most recent workcenter of an item and determine the next workcenter to which the item should be moved to continue the manufacture of the item. The shopfloor system has input devices to record when an item has arrived at a workcenter and output devices to direct where the item should move to continue the manufacturing process. Input devices are barcode readers, computer terminals, etc. that are used to indicate that an item is at a specific workcenter. The output devices are computer displays, barcode reader displays, automated materials handlers, etc. that are used to direct the movement of the item to the next step in the process. The shopfloor system records the workcenter of an item, determines from the route for the item if the item is suppose to be where it was recorded and if at the correct workcenter, the next workcenter to which the item should be moved. The shopfloor system can provide information specific to the workcenter to manufacture the item and can collect information about the item for that process step. The information may be used to determine the next workcenter for the item. For example, the process step for the item may test the item. If the item passes, it continues to the next step in the sequence. If the item fails, the item is moved to a repair workcenter to fix the defect. The conditional branch or “pass-fail” in the process is defined in the route so the shopfloor system can collect the information and control the movement of the item.

The shopfloor system must have a mechanism to match the physical item with the logical tracking in the shopfloor system. The physical item can be labeled with a machine-readable tag like a barcode or radio frequency tag. Or the physical item can be labeled with a human readable tag like a paper label with information that identifies the item or group of items. The shopfloor system has a route for each item and the most recent workcenter for each item. From the route and the most recent workcenter, the shopfloor system can determine the next workcenter for each item. The shopfloor system can provide the most recent workcenter for an item the next workcenter for that item so the item can be moved to the next workcenter. The shopfloor system can also provide the next workcenter with an indicator to expect the item. The next workcenter can have a list of all items expected to arrive at that workcenter.

Shopfloor systems are similar to workflow systems used to control the processes on electronic documents and other processes in that the processes are sequences of process steps that are executed at different workcenters and the sequences can be described in routes. Shopfloor systems differ in that the work items are physical and the work item must be identified and matched to the logical tracking and control in the system. A shopfloor system can be applied to a paper document processing system where the documents are physical and must be identified for tracking and control. While the shopfloor system capabilities are described as applied to a manufacturing process, these can be applied to the control and tracking of packages in a shipping system, items in a warehouse, luggage in a baggage system, etc. where the flexibility of a route is used to replace a hard coded process for the item. Shopfloor systems are a program or sets of cooperative programs. Some shopfloor systems are a program in mainframe computer or mini-computer with terminals at the workcenters. The single program tracked and controlled the movement of the items. Some shopfloor systems are a set of programs in a set of computers, the client-server model, where programs in Personal Computers (PC) cooperatively work with a program on a central server, usually a database, to implement the functions of the shopfloor system. The PC's connect to the server using a local area network (LAN). The communications protocols used on the LAN permit the PC's to access the server and the records in the database. These protocols are not used on the open Internet or between companies because they provide too many capabilities that may be used to cause damage to stored information and programs in computers connected to the LAN. Companies have special computers called “Firewalls” that connect the LAN to the Internet. The Firewall computers protect the internal LAN from external attack using the Internet by filtering the information packets and permitting only “safe” protocol packets through the firewall. Most Firewalls permit communication packets that use the Hyper Text Transfer Protocol (HTTP) and Hyper Text Transfer Protocol Secure (HTTPS), the encrypted version, to pass since these are used for the World Wide Web and are designed to limit the access to only the functions of Web browsers The because of the LAN or terminal connection between the server and workcenters, mainframe and mini-computer and client-server shopfloor systems are trapped within the Firewalls of their companies.

Many products in the electronics industry are no longer manufactured by the company that labels the product but are made by companies that specialize in providing manufacturing services called electronic manufacturing service (EMS) providers or contract manufacturers. This new business model expanded the factory floor beyond the fours walls of the traditional factory and the shopfloor control systems had to control and track manufacturing processes outside of the building. The EMS also outsourced some of the manufacturing process step to third level suppliers, adding to the complexity and the requirements on the shopfloor control systems. In addition, some decisions of where the outsourced processes steps are to be done is made at the last minute since the decisions are made based on real time cost and capacity. The shopfloor control system had to be able to extend and be set up quickly. Since manufacturing cost is important, the cost of the shopfloor system is important and must be kept to a minimum. A product can be manufactured at multiple global EMS sites. Each EMS can also outsource process steps to third party providers. The control of the process and information on products manufactured must be centralized but must be accessible globally by workcenters for information collection and process control, and by users for information viewing. The Internet is a global, ubiquitous interconnection to which computers and other devices can connect. Prior art shopfloor systems have means to publish information using the Internet. However, these systems still require that the terminals or computers controlling and tracking the manufacturing process be connected to the LAN with the mainframe/mini or server and have the shopfloor programs in the computers at the workcenters. The Internet can serve as a wide area network (WAN), or extended LAN, or Virtual Private Network (VPN) and some shopfloor systems designed to operate on a LAN can be adapted to operate using the Internet as a LAN. Most Firewalls do not permit the communication protocols required to use the Internet as a WAN or LAN for applications designed for a LAN since these protocols permit uncontrolled access to the LAN. These “Internet adapted” shopfloor applications require firewall modifications to operate. In addition, software must be installed on the computers at the workcenters. To add a workcenter at another company, for example at an EMS, the EMS must make their LAN or part of their LAN a segment of the LAN used by the shopfloor system. This opens significant security issues that many companies are not willing to address. In addition the shopfloor software must be installed in a PC or workstation at the workcenter. Adding a computer to support a workcenter for a LAN based shopfloor system to use the Internet takes considerable time, effort, and cost even if the significant security issues are addressed.

The equipment that connects to the Internet are no longer just computers but also many other devices such as cell phones, personal digital assistants, wireless barcode readers, video game consoles, GPS navigation systems, etc. Many of these new Internet devices will be used to collect shopfloor information, provide process control information, and view information on the state of products manufactured on the shopfloor.

Software applications that use the Internet using the widely accepted standards and browsers are easy to install and use. It is desirable to have a shopfloor control system that is flexible, easy to set-up, and workcenters that may be added quickly at low effort and cost. It is also desirable to minimize the impact to the information system staff by minimizing changes to Firewalls and installation of software and devices.

### BRIEF DESCRIPTION OF DRAWINGS

FIG. 1 illustrates a route with three steps.

### DESCRIPTION OF THE INVENTION

The Manufacturing Information Web Service (MIWS) is not a LAN based client server application where the LAN is replaced by the Internet but a new design and implementation of the functions using the capabilities of the Internet web browser in an Internet device and using information packets that pass through standard Firewalls using HTTP and HTTPS protocols. MIWS clients can be any Internet device. A new workcenter may be added by providing the Uniform Resource Locator (URL) of the MIWS and creating a user id and password. This may be implemented in a matter of minutes. The Internet device need not be a PC or workstation but any suitable Internet device such as a Internet enable wireless barcode reader. The workcenter may be removed by removing the user id from the system. An Internet device can be used for the program management functions to create and edit routes, create and release work orders, etc. and view the information about products and items in the system. A user to perform the program management and view capabilities can be added by adding a user id and password and providing the URL. The user can use any Internet device to access MIWS. A user can check on the status of products from the airport using an Internet enabled cell phone or from a video game console in the middle of a game. The user can be removed by removing the user id. MIWS provides significant flexibility for companies to extend the control and visibility of the manufacture of their products into their manufacturing service providers and the multiple layers of service providers below them. Wherever their product goes, the manufacturing service provider can provide control and visibility by connecting to MIWS using the Internet. The connection can be created in minutes and removed in minutes. All of this can be implemented remotely using the Internet.

The Internet browser is significantly different from a client in a client-server model. The Internet browser does not have persistent information storage. Each web page must create its context based on information passed to the page from the calling page or information in the web page server. A limited amount of information can be stored on the Internet device if the device supports “cookies”, a small addressable packet of information that a web page server can send to the Internet device that can be retrieved later by a web page server. The web page in a browser cannot access information stored on the Internet device or the web server except in very limited cases. The Internet limitations are to protect the Internet device and the other devices connected to the LAN. The client software of a client server application cannot be mapped to code a web page and the software of the server cannot be mapped to code the web page server to migrate a client server application to a web page with web page server application.

Manufacturing Information Web Service (MIWS) is provided a route, a sequence of workcenters and process steps to manufacture a product. For each item to be built, the MIWS has a route position storage that stores the current position, the step in the route, for that item. The step in the route defines the workcenter and the process step to be done on the item. The current workcenter can be also be stored in the route position storage to minimize the accesses to the route. The workcenter is a physical location where a process step is performed and is not connected to the Internet. The workcenter has an Internet device that serves as the input and output for the workcenter and the Internet device is connected to the Internet. The phrase “lnternet device is designated as the workcenter” means that the Internet device serves as the workcenter with respect to the MIWS. The MIWS provides a web page to the Internet device designated as the workcenter to identify the item upon which a process step is to be performed. The first operation at the workcenter is to identify the item to insure that the item is supposed to be at that workcenter. The item may have a barcode or other machine-readable identifier and the identifier is read and transferred to the item identification web page. Or the item may not have a machine-readable identifier and a person identifies the item by reading a label or by experienced observation. The MIWS can provide a selectable list of items that are expected at the workcenter and the operator can select from the list the item. The item identification is sent back to the MIWS. The MIWS determines from the route position for the item if the item is at the correct workcenter. If the item is at the correct workcenter and if the route indicates a process step is to be performed, a web page with instructions for the process step is sent by the MIWS. The Internet device sends a web page response back to the MIWS after the process step is completed. Information about the item and the process step can be collected in the web page. The MIWS determines from the route, the next route step and next workcenter for the item, updates the route position for the item to the next route step and next workcenter, and returns a web page to identify another item. In addition, the web page to identify an item can include an indication that the item identified is at the correct workcenter and indicate the next workcenter for the item. The item is moved to the next workcenter. This cyclic process is repeated until the item moves through the sequence of workcenters and process steps in the route and the item is completed. In the simplest case, a process step is not indicated for a route step and just the barcode is read or the description of the item is selected and the item identification is used to record that the item was at the workcenter in the sequence defined in the route. If the workcenter with the item is not at the correct workcenter for the item, then a web page with the correct workcenter is sent to the Internet device so the item can be moved to the correct workcenter. This moves the item back on to the sequence of workcenters as designated by the route.

As an item moves through the sequence of the route, information such as the time for each step, the workcenter operator, process information, defect information, etc. can be collected for analysis. This information is collectively called the “move history” and “quality reports” for the item. The information collected for the items manufactured can be viewed using Internet devices. The current workcenter of an item can be viewed. The collective view of items at workcenters is called a view of the Work In Process or WIP and can be used to visually represent the progress of items as they are manufactured. The information is collected in near real time so all of the reports are near real time. A process step may require that a sequence of sub-process steps be performed on the item at that workcenter. A web page may be adapted to sequence the sub-process steps or the sub-process steps may be a sequence of process steps in the route performed at that workcenter. Depending on the complexity and reusability of the sub-process steps, the decision to select the adapted web page or the sequence of process steps in the route can made by the implementers of the web pages. Both mechanisms can be used to create the web pages to support complex processes. The process and sub-process steps may have hypertext links to additional instructions, information, audio, videos, etc. to assist the operator to perform the process step. The hyperlinks may be adapted to contain parameters so that the information is adapted specifically to the item on which the process is performed. For example, the item information in MIWS indicates that the item is to have a specific color and the hyperlink contains a parameter for the color so that the instructions and video show the item with the specified color.

The manufacturing process can include an inspection or test process step that may result in the item being sent to a repair workcenter rather that the normal workcenter. At the inspection or test process step in the route, MIWS provides a web page to return an indication of pass or fail for the item. The workcenter sets the indicator and submits the web page to MIWS. If the indicator is pass, then MIWS takes the “pass” branch in the route and directs the item to the normal workcenter. If the indicator is fail, the MIWS takes the “fail” branch in the route and directs the item to the workcenter on the “fail” branch, for example a repair workcenter. In addition, the MIWS can send a web page to the Internet device requesting information about the failure such as the failure symptoms or location. The failure information is stored in the MIWS with the failure so the information can be used when the item is repaired and for analysis to help determine the cause of the failure. Additional information can be collected at the repair workcenter as the failure in the item is repaired or if the failure causes the item to be scrapped.

The workcenter designation for the Internet device is determined when the Internet device first logs into MIWS. Each web page submitted to MIWS by the Internet device must have the workcenter designation. If the Internet device supports cookies, a cookie is sent to the Internet device with the workcenter designation and the cookie is read with the web pages submitted by the Internet device. Much of this can be automated using the session cookie to minimize the cookie overhead once the session is established. The cookie can be used at the login process to determine if the Internet device has a designated workcenter from a previous login and bypass asking the Internet device the workcenter. If the Internet device does not support cookies, then the workcenter designation must be first established at the Internet device login. Then, each page sent by MIWS has the workcenter designation and the workcenter designation is sent back with each page submitted to MIWS. If the Internet device loses a web page, the workcenter designation process may be repeated to re-establish the workcenter designation of the Internet device.

### DESCRIPTION OF A PREFERRED EMBODIMENT

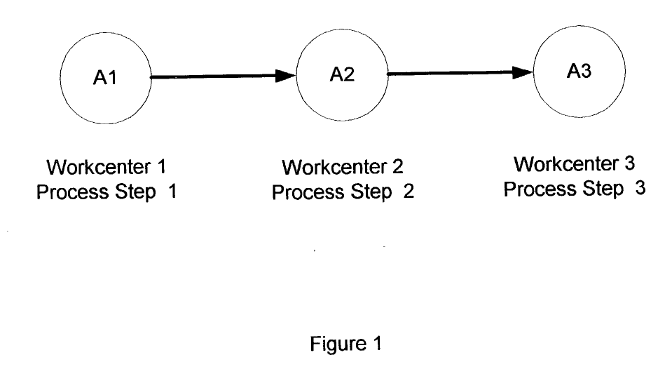

The route can be represented as rows in a relational database table. A route, called Route A, is illustrated in Table 1. Route Table. Each row of the Route Table indicates for a step in the route, the name in the Current column, the next step, the name in the Next column, the workcenter, the name in the Workcenter column, and the process step, the name in the Process Step column. For example, the first row in the Route Table indicates that when the current is step A1, the next step is A2, the workcenter is Workcenter 1 and the process step is Process Step 1. When the current step is A2, the next step is A3, the workcenter is Workcenter 2, and the process step is Process Step 2. When the current step is A3, the next step is DONE so A3 is the last step in Route A, the workcenter is Workcenter 3 and the process step is Process Step 3. This is the same route illustrated in FIG. 1.

TABLE 1
Route Table

| Route | Current | Next | Workcenter | Process Step |
|---|---|---|---|---|
| Route A | A1 | A2 | Workcenter 1 | Process Step 1 |
| Route A | A2 | A3 | Workcenter 2 | Process Step 2 |
| Route A | A3 | DONE | Workcenter 3 | Process Step 3 |

The memory of the MIWS is a relational database where the route position is stored as a row in the Route Position Table illustrated as Table 2. For example, the first row of the Route Position Table illustrates that the item or group called Unit 1 is at route step A1 in the route called Route A.

TABLE 2
Route Position Table

| Unit ID | Current | Route |
|---|---|---|
| Unit 1 | A1 | Route A |
| Unit 2 | A2 | Route A |

Table 2 is augmented to accommodate barcode identifiers and groups of items without barcodes where the barcode is in a column and the quantity is kept in a second column. In addition, this table also includes the current workcenter to reduce the number of table queries. The current workcenter can also be determined by using the current route position as an argument to query the route table. The web page requesting the item identifier accepts a barcode or other machine-readable identifier and has a list of item identifiers for items or groups of items without identifiers that the route indicates should be at that workcenter. For example, Workcenter 1 would display that Unit 1 with quantity 5 should be at that workcenter. In a preferred embodiment, the list of item descriptions displayed at Workcenter 1 is a web hyperlink with the Route Position with Barcode and Quantity Table row that invokes a web page for Process Step 1. Note that a list box with the list of item descriptions, a list with radio buttons, a list with check boxes, or other web data structures can be used to create a selectable list of items and/or item descriptions so the workcenter operators can submit the description of the item. When Unit 1 is at Workcenter 1, the hyperlink is selected and the web page for Process Step 1 is displayed. When the Process Step 1 web page is submitted back to the MIWS, Route A is used to determine that the next step is A2, the Route Position with Barcode and Quantity Table row is updated to reflect the next position in the route and next workcenter. The web page requesting the item identifier also displays the next workcenter, A2, for the item that just completed the process step so the item can be moved to the next workcenter.

At Workcenter 2, the barcode for Unit 2 is entered into the web page requesting the identifier. In a preferred embodiment, the barcode 12345 is used to query the Route Position with Barcode and Quantity Table to select a match in the Barcode column. The barcode 12345 matches the row for Unit 2 that indicates that Unit 2 should be at Workcenter 2 and the process step is Process Step 2. Since Workcenter 2 submitted the barcode, the item is at the correct workcenter. MIWS presents a web page for Process Step 2. When the Process Step 2 web page is submitted back to the MIWS, Route A is used to determine that the next step is A3 and next workcenter is Workcenter 3, the Route Position with Barcode and Quality Table row is updated to reflect the new position in the route and the next workcenter. The web page requesting the identifier displays the next workcenter for the item or group that just completed the process step.

TABLE 3
Route Position with Barcode and Quantity Table

| Unit ID | Current | Workcenter | Route | Barcode | Quantity |
|---|---|---|---|---|---|
| Unit 1 | A1 | Workcenter 1 | Route A | QTY | 5 |
| Unit 2 | A2 | Workcenter 2 | Route A | 12345 | 1 |

A process step can be an inspection where a pass or fail decision can be made. If the item passes the inspection, the route indicates a sequence of process steps or else if the item fails the inspection, the route indicates an alternate sequence of process steps. Route B in Table 4 illustrates a route with a Pass Fail conditional branch. In Route B, an inspection process called Process Step 4 is done at Workcenter 4 at step B1. If the inspection passes, the next step is B2. If the inspection fails, the next step is B3. In a preferred embodiment, for an item using Route B and at route step B1, after the item is identified using barcode or the link for an item without a barcode, the MIWS presents a pass or fail web screen for Process Step 4. The workcenter indicates the inspection results as a pass or fail in the web page and submits the web page to the MIWS. The MIWS uses the result to select the next route step based on matching the value in the Condition field for the current row in the route. If the result was Pass, then the row with B2 as the next route step is selected. If the result was Fail, then the row with B3 as the next route step is selected. A process step after a failure can be a web page to enter data about the failure. The failure data is stored in the MIWS for use at the repair workcenter or analysis of failure data.

TABLE 4
Route with Pass Fail Conditional Branch

| | | | | | |
|---|---|---|---|---|---|
| Route | Current | Next | Workcenter | Process Step | Condition |
| Route B | B1 | B2 | Workcenter 4 | Process Step 4 | Pass |
| Route B | B1 | B3 | Workcenter 4 | Process Step 4 | Fail |
| Route B | B2 | DONE | Workcenter 5 | Process Step 5 | |
| Route B | B3 | DONE | Workcenter 6 | Process Step 6 | |

The actions at a workcenter are connected to MIWS using an Internet device. The Internet device can be a PC with a web browser, equipment with an embedded computer connected to the Internet, wireless barcode reader, PDA, cell phone, etc. The MIWS is designed to use the HTTP and HTTPS protocols and provide all of the functions as web pages. The use of Firewall friendly protocols permits rapid connection and set up. An Internet device is all that is required to access the web service using the URL of the Web service. A user ID and password are all that is required. Access to MIWS can run concurrent with existing system since browser does not interfere with other applications. The browser functions can integrate to other applications in the Internet device using OLE automation and other tools. A route can have a conditional branch and pass-fail operation at workcenter. Workcenter can collect defect information for a failure. Since Internet devices can easily connect, MIWS has low barrier to connect and rapid deployment since no new software is needed at the client. Since the browser is the only requirement at the client, new capabilities added without the need to upgrade each client. With MIWS users can control manufacturing processes and access information from anywhere they can access the Internet.

The Manufacturing Information Web Service is implemented as a set of software programs and web pages written in Java, C++, Microsoft Visual Basic, Active Server Pages, Microsoft.Net, or a number of programming languages. The programs may use a database for storing workcenter, process step, route information as illustrated in the Tables, and storing information collected in the manufacturing process. Database programs are available from Oracle, IBM, Microsoft, and many other providers. The integration to the Internet uses a Web server program that provides the web pages for the client transactions. Microsoft, Netscape, and others provide Web server programs. These programs and databases execute in computers manufactured by, for example, IBM, Sun, Dell, and HP. The computers may be, for example, PC's, workstations, mainframes, and hand-held computers. The computers may have an operating system such as UNIX, LINUX, Microsoft 2000, and IBM OS/9000. The computer is connected to a network that may be, for example, a WAN, Internet, Intranet, LAN or wireless LAN connected to the Internet, or a wireless Internet. Those skilled in the art are aware of the programs and hardware available to implement the functions ascribed to the Manufacturing Information Web Service. The programs provide large blocks of function and the selection of programs will influence the specific implementation of the functions of a Manufacturing Information Web Service.

I claim:

1. A Manufacturing Information Web Service and an Internet device, both connected to the Internet, and an item at a workcenter where the Internet device is designated as a workcenter and the Manufacturing Information Web Service is provided a route, a sequence of workcenters and process steps;
Wherein the Manufacturing Information Web Service includes a route position storage with the current position in the route for the item, current workcenter and the item identifier; and
Sends to the Internet device a web page to identify the item;
The Internet device enters the item identity into the web page and submits it to the Manufacturing Information Web Service;
The Manufacturing Information Web Service compares the item identifier with the item identifier in the route position storage to determine current position in the route and the current workcenter;
Compares the current workcenter with the Internet device workcenter and if the same then
Determines from the route a first process step;
Sends to the Internet device a web page for the first process step;
The Internet device performs the first process step and submits the web page for the first process step to the Manufacturing Information Web Service;
The Manufacturing Information Web Service Determines from the route the next workcenter in the route and the next position in the route;
Updates the route position storage to the next workcenter and next position in the route;
Sends to the internet device a web page to identify an item.
Else
Sends to the Internet device a web page with the current workcenter for the item The Internet device responds
The Manufacturing Information Web Service sends to the Internet device a web page to identify an item.

2. The Manufacturing Information Web Service of claim 1, wherein the Manufacturing Information Web Service sends to the Internet device an indication of the next workcenter for the item.

3. The Manufacturing Information Web Service of claim 1, wherein the route indicates that the first process step is not needed and the web page for the first process step is not sent to the Internet device and the Manufacturing Information Web Service Determines from the route the next workcenter in the route and the next position in the route;
Updates the route position storage to the next workcenter and next position in the route;
Sends to the Internet device a web page to identify an item.

4. The Manufacturing Information Web Service of claim 1, wherein the web page to identify an item contains a selectable list of items expected at the Internet device designated workcenter and the item identity is selected from the list

5. The Manufacturing Information Web Service of claim 1, wherein the web page to identify an item has a machine-readable label entry; the item has a machine-readable label and the machine-readable label is entered in the web page as the item identity.

6. The Manufacturing Information Web Service of claim 1, wherein the route designates a conditional branch at the Internet device designated workcenter where the route has a pass sequence of workcenters and a fail sequence of workcenters; the Manufacturing Information Web Service sends to the Internet device a web page to return a pass or fail choice; the Internet device indicates a pass or a fail in the web page and submits the web page to the Manufacturing Information Web Service; the Manufacturing Information Web Service selects the next workcenter from workcenter sequence corresponding to the pass or fail response from the Internet device.

7. The Manufacturing Information Web Service of claim 1, wherein the route designates a conditional branch at the Internet device designated workcenter where the route has a pass sequence of workcenters and a fail sequence of workcenters; the Manufacturing Information Web Service sends to the Internet device a web page to return a pass or fail choice; the Internet device indicates a fail and submits the web page to the Manufacturing Information Web Service; the Manufacturing Information Web Service selects the next workcenter from workcenter sequence corresponding to the fail response from the Internet device and sends a web page to the Internet device requesting data on the failure; the internet device enters the failure data and submits the web page to the Manufacturing Information Web Service and the Manufacturing Information Web Service stores the data with the failure.

8. The Manufacturing Information Web Service of claim 1, wherein the route designates a second process step at the current workcenter and the Manufacturing Information Web Service after receiving the response from the Internet device for the first process step sends to the Internet device a web page with the second process step; and the Internet device responds to the web page with the second process step; and The Manufacturing Information Web Service
Determines from the route the next workcenter in the route and the next position in the route;
Updates the route position storage to the next workcenter and next position in the route;
Sends to the Internet device a web page to identify an item.

9. An Internet Shopfloor Service; an Internet device designated as a workcenter, both connected to the Internet; an item at a workcenter; a route, a sequence of workcenters;
Wherein the Internet Shopfloor Service has the current route position and workcenter for the item and sends a web page to identify an item to the Internet device; and
Responds to the Internet device response with the item identity by comparing the current workcenter for the item with the Internet device designated workcenter and
if the same, determines from the current route position and route, a first process step and sends a web page to the Internet device with the first process step to the Internet device; and
Responds to the Internet device response with the first process step completion by determining from the route and current route position the next workcenter and next route position;
Updates the current workcenter to the next workcenter and current route position to the next route position; and
Sends a web page to identify an item to the Internet device;
Else sends a web page with the current workcenter to the Internet device; and
Responds to the Internet device by sending a web page to identify an item to the Internet device.

10. The Internet Shopfloor Service of claim 9, wherein the Internet Shopfloor Service responds to the Internet device with a web page indicating the next workcenter for the item.

11. The Internet Shopfloor Service of claim 9, wherein route indicates that the first process step is not needed and the web page with the first process step is not sent to the Internet device and the Internet Shopfloor Service responds to the response from the Internet device by determining from the route and current route position the next workcenter and next route position;
Updates the current workcenter to the next workcenter and current route position to the next route position; and
Sends a web page to identify an item to the Internet device.

12. The Internet Shopfloor Service of claim 9, wherein the item identity web page includes a selectable list of items expected at the Internet device designated workcenter from which the item identity can be selected.

13. The Internet Shopfloor Service of claim 9, wherein the item identity web page includes a machine-readable entry where the machine-readable label of the item is entered to identify the item.

14. The Internet Shopfloor Service of claim 9, wherein the route indicates a second process step at the Internet device designated workcenter and sends in response to the Internet device a web page with the second process step; and responds to the Internet device with the completion of the second process step by determining from the route and current route position the next workcenter and next route position;
Updates the current workcenter to the next workcenter and current route position to the next route position; and
Sends a web page to identify an item to the Internet device.

15. An Internet Device Designated as a Workcenter; an Internet shopfloor service, both connected to the Internet; an item at a workcenter; a route, a sequence of workcenters;
wherein the Internet Device Designated as a Workcenter receives a web page to identify an item from the Internet shopfloor service and responds with the item identifier;
if the workeenter for the item matches the Internet Device designated workcenter. the Internet shopfloor service responds with a web page for a first process step;
the Internet Device Designated as a Workcenter responds when the first process step is completed;
the Internet shopfloor service responds with a web page to identify an item else
the Internet shopfloor service responds with a web page with the workcenter for the item.
The Internet Device Designated as a Workcenter responds; and
the Internet shopfloor service responds with a web page to identify an item

16. The Internet Device Designated as a Workcenter of claim 15, wherein the Internet shopfloor service responds with the next workcenter for the item.

17. The Internet Device Designated as a Workcenter of claim 15, wherein the web page to identify an item contains a selectable list of items expected at the workcenter designated to the Internet device from which the item identity can be selected.

18. The Internet Device Designated as a Workcenter of claim 15, wherein the web page to identify an item contains a machine-readable entry and the machine-readable label of the item is entered to identify the item.

19. The Internet Device Designated as a Workcenter of claim 15, wherein the route indicates the first process step is not needed and the Internet shopfloor service responds with a web page to identify an item.

20. The Internet Device Designated as a Workcenter of claim 15, wherein the route indicates a second process step at the Internet device designated workcenter and the Internet shopfloor service sends a web page with the second process step in response to the completion of the first process step and sends a web page to identify an item in response to the completion of the second process step.
